(19) United States
(12) Patent Application Publication
(10) Pub. No.: US 2007/0146303 A1
(43) Pub. Date: Jun. 28, 2007

(54) Liquid crystal television receiver with liquid crystal panel and its illumination apparatus, liquid crystal display, electric device, liquid crystal projector, and liquid crystal display control method for controlling liquid crystal display

(75) Inventors: Takeshi Kaminosono, Osaka (JP); Atsuhiko Nagamune, Osaka (JP); Yasuhiko Kawai, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/646,712

(22) Filed: Dec. 28, 2006

(30) Foreign Application Priority Data
Dec. 28, 2005 (JP) 2005-379592

(51) Int. Cl. G09G 3/36

(52) U.S. Cl. 345/102

(57) ABSTRACT

A liquid crystal television receiver reduces the brightness of a backlight which generates light to be passed through a liquid crystal panel and thereby forms an image, to a brightness invisible to human eyes. After the brightness is reduced, a panel signal to the liquid crystal panel is controlled to change from the ON state to the OFF state. After the panel signal is controlled to change to the OFF state, the backlight is controlled to change from the ON state to the OFF state. In this way, the backlight of the liquid crystal panel is controlled so that disturbance in image, which occurs when the panel signal to the liquid crystal panel is changed from the ON state to the OFF state, can easily be prevented from being seen by users.

### BACKGROUND OF THE INVENTION

1. Field of the Invention

The present invention relates to a liquid crystal television receiver, a liquid crystal display apparatus, an electric device, a liquid crystal projector apparatus, and a liquid crystal display control method. In particular, the invention relates to a liquid crystal television receiver, a liquid crystal display apparatus, an electric device, a liquid crystal projector apparatus, and a liquid crystal display control method that are characterized in terms of control of a liquid crystal panel.

2. Description of the Background Art

There has conventionally been a method of driving a plasma address display panel. Specifically, when the power is to be turned off, power supply to a liquid crystal drive circuit is first stopped and thereafter power supply to a plasma drive circuit is stopped (see for example Japanese Patent Laying-Open No. 08-313868 (hereinafter “Patent Document 1”).

Further, there have been liquid crystal display driving apparatus and method. Specifically, when the power is to be turned on or off, a mask period is provided for allowing a liquid crystal panel to display nothing so as not to show disturbance in image or the like (see for example Japanese Patent Laying-Open No. 11-212522 (hereinafter “Patent Document 2”).

Furthermore, there have been a liquid crystal display system, a display signal supply apparatus and a liquid crystal display apparatus. Specifically, upon accepting an externally given instruction to turn off the power, a common electrode and all or a part of a plurality of pixel electrodes which are constituents of a liquid crystal panel are set to substantially zero potential (see for example Japanese Patent Laying-Open No. 2003-050565 (hereinafter “Patent Document 3”).

Moreover, there have been a liquid crystal display apparatus, a liquid crystal display apparatus control method and a mobile terminal. Specifically, disturbance on the screen when the power is turned off can be prevented in the following way. When the power is to be turned off, active elements for all pixels of a pixel portion are switched on and simultaneously all signal lines are set to the same potential as that of a common electrode of pixels, thereby instantaneously forming, for all pixels, a discharge path of the pixel electrodes, active elements, signal lines and common electrode in this order. Thus, through the discharge path, remaining charge of all pixels is instantaneously discharged. Accordingly, even if the power is suddenly turned off, there is no afterglow which occurs due to remaining charge within pixels (see for example Japanese Patent Laying-Open No. 2004-045785 (hereinafter “Patent Document 4”).

However, the technique disclosed in Patent Document 1 relates to the method of driving the plasma address display panel. In contrast, the present invention relates to a liquid crystal display apparatus for example. Therefore, the technique disclosed in Patent Document 1 cannot solve problems of the present invention.

Further, the techniques disclosed in Patent Documents 2 to 4 control a liquid crystal panel and thus require complicated control, and backlight control is not included in the constitution of the invention.

### SUMMARY OF THE INVENTION

The present invention has been made to solve the above-described problems. An object of the present invention is to provide a liquid crystal television receiver, a liquid crystal display apparatus, an electric device, a liquid crystal projector apparatus, and a liquid crystal display control method that control an illumination apparatus of a liquid crystal panel so that any disturbance of an image when the liquid crystal panel is turned off can easily be prevented from being seen by a user.

In order to solve the problems described above, according to an aspect of the present invention, a liquid crystal display apparatus includes a brightness reduction control unit, a panel-off control unit and an illumination-off control unit. The brightness reduction control unit reduces the brightness of the illumination apparatus generating light to be passed through a liquid crystal panel or reflected from the liquid crystal panel and thereby forming an image, to a brightness invisible to human eyes. After the brightness is reduced by the brightness reduction control unit, the panel-off control unit controls a video signal to the liquid crystal panel to be changed from an ON state to an OFF state. The illumination-off control unit controls the illumination apparatus to be changed to the OFF state after the video signal is controlled to be changed from the ON state to the OFF state.

In accordance with the present invention, the liquid crystal display apparatus reduces the brightness of the illumination apparatus, which generates light to be passed through the liquid crystal panel or reflected from the liquid crystal panel and thereby forms an image, to a brightness invisible to human eyes. After the brightness is reduced, the video signal to the liquid crystal panel is controlled to change from the ON state to the OFF state. After the video signal is controlled to change to the OFF state, the illumination apparatus is controlled to change from the ON state to the OFF state.

Thus, the liquid crystal display apparatus can be provided that controls the illumination apparatus of the liquid crystal panel to easily prevent disturbance in image, which occurs when the video signal to the liquid crystal panel is changed from the ON state to the OFF state, from being seen by the user.

Preferably, the brightness reduction control unit reduces the brightness on condition that an instruction signal for instructing to stop function of the liquid crystal panel is input.

Preferably, the brightness reduction control unit reduces the brightness to a predetermined brightness invisible to human eyes. Still preferably, the predetermined brightness is a minimum brightness of the illumination apparatus.

Preferably, the liquid crystal display apparatus further includes an illuminance measurement unit measuring an ambient illuminance of the liquid crystal display apparatus. The brightness reduction control unit reduces the brightness to a brightness according to the illuminance measured by the illuminance measurement unit.

In accordance with the present invention, the liquid crystal display apparatus measures the ambient illuminance and the brightness of the illumination apparatus is reduced to a brightness invisible to human eyes according to the illuminance. Therefore, according to the illuminance, the brightness can be reduced with a degree of change in brightness that is as small as possible. Accordingly, the degree of change in electric power supplied to the illumination apparatus can be reduced. As a result, the degree of change in load of electric power of the liquid crystal display apparatus can be reduced. Further, the stability of the power supply voltage of the liquid crystal display apparatus can be improved.

Preferably, the brightness reduction control unit gradually reduces the brightness.

In accordance with the present invention, the liquid crystal display apparatus gradually reduces the brightness of the illumination apparatus to a brightness invisible to human eyes. Thus, the degree of brightness change per time is smaller and the degree of change in electric power supplied to the illumination apparatus can accordingly be reduced. As a result, the degree of change in load of electric power of the liquid crystal display apparatus can be reduced. Further, the stability of the power supply voltage of the liquid crystal display apparatus can be improved.

Preferably, the illumination apparatus is a backlight.

According to another aspect of the present invention, an electric device has the above-described liquid crystal display apparatus.

Thus, the electric device can be provided that controls the illumination apparatus of the liquid crystal panel to easily prevent disturbance in image, which occurs when the video signal to the liquid crystal panel is changed from the ON state to the OFF state, from being seen by the user.

According to still another aspect of the present invention, a liquid crystal television receiver has the above-described liquid crystal display apparatus.

Thus, the liquid crystal television receiver can be provided that controls the illumination apparatus of the liquid crystal panel to easily prevent disturbance in image, which occurs when the video signal to the liquid crystal panel is changed from the ON state to the OFF state, from being seen by the user.

According to a further aspect of the present invention, a liquid crystal projector apparatus has the above-described liquid crystal display apparatus.

Thus, the liquid crystal projector apparatus can be provided that controls the illumination apparatus of the liquid crystal panel to easily prevent disturbance in image, which occurs when the video signal to the liquid crystal panel is changed from the ON state to the OFF state, from being seen by the user.

According to a further aspect of the present invention, a liquid crystal display control method for controlling a liquid crystal display apparatus includes the steps of: reducing a brightness of an illumination apparatus generating light to be passed through a liquid crystal panel or reflected from the liquid crystal panel and thereby forming an image, to a brightness invisible to human eyes; controlling a video signal to the liquid crystal panel to be changed from an ON state to an OFF state, after the brightness is reduced; and controlling the illumination apparatus to be changed from the ON state to the OFF state after the video signal is controlled to be changed to the OFF state.

In accordance with the present invention, the liquid crystal display control method reduces the brightness of the illumination apparatus, which generates light to be passed through the liquid crystal panel or reflected from the liquid crystal panel and thereby forms an image, to a brightness invisible to human eyes. After the brightness is reduced, the video signal to the liquid crystal panel is controlled to change from the ON state to the OFF state. After the video signal is controlled to change to the OFF state, the illumination apparatus is controlled to change from the ON state to the OFF state.

Thus, the liquid crystal display control method can be provided that controls the illumination apparatus of the liquid crystal panel to easily prevent disturbance in image, which occurs when the video signal to the liquid crystal panel is changed from the ON state to the OFF state, from being seen by the user.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram schematically showing a configuration of a liquid crystal television receiver in a first embodiment of the present invention.

FIG. 2 is a flowchart showing a flow of a panel-off process performed by the liquid crystal television receiver in the first embodiment of the present invention.

FIG. 3 is a timing chart showing panel-off control timing by the liquid crystal television receiver in the first embodiment of the present invention.

FIG. 4 is a flowchart showing a flow of a panel-off process performed by a liquid crystal television receiver in a second embodiment of the present invention.

FIG. 5 is a timing chart showing panel-off control timing by the liquid crystal television-receiver in the second embodiment of the present invention.

FIG. 6 is a flowchart showing a flow of a panel-off process performed by a liquid crystal television receiver in a third embodiment of the present invention.

FIG. 7 is a timing chart showing panel-off control timing by the liquid crystal television receiver in the third embodiment of the present invention.

FIG. 8 is a block diagram schematically showing a configuration of a liquid crystal monitor in a fourth embodiment of the present invention.

FIG. 9 is a flowchart showing a flow of a panel-off process performed by the liquid crystal monitor in the fourth embodiment of the present invention.

FIG. 10 is a block diagram schematically showing a configuration of a liquid crystal projector according to a modification of the present invention.

### DESCRIPTION OF THE PREFERRED EMBODIMENTS

In the following, embodiments of the present invention are described in detail with reference to the drawings. In the drawings, like or corresponding components are denoted by like reference characters and a description thereof is not repeated.

### First Embodiment

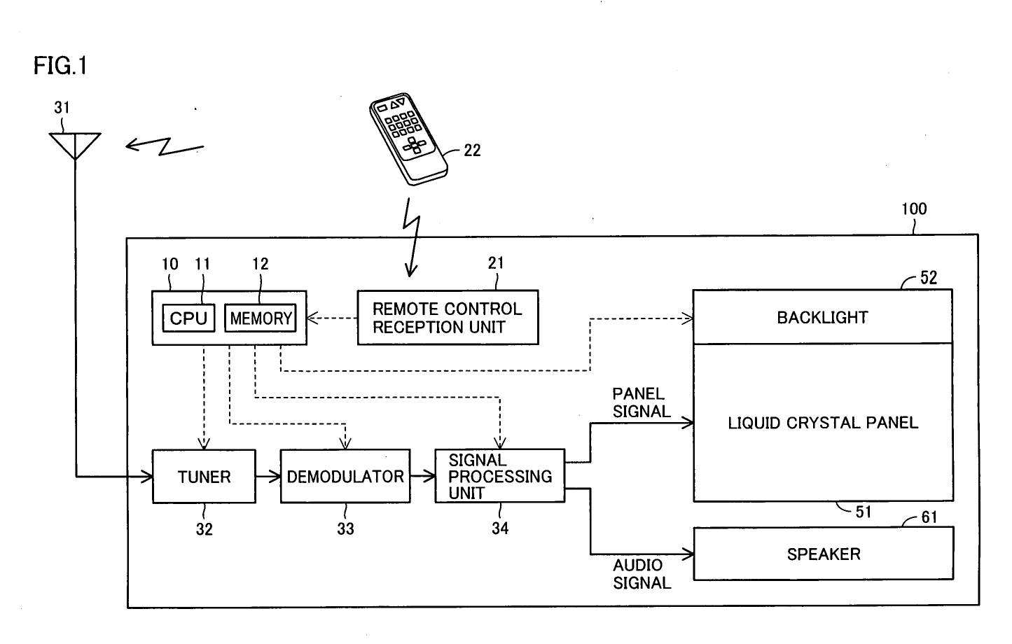

Referring to FIG. 1, a liquid crystal television receiver 100 includes a control unit 10, a remote control reception unit 21, a tuner 32, a demodulator 33, a signal processing unit 34, a liquid crystal panel 51, a backlight 52, and a speaker 61.

Control unit 10 includes a CPU (Central Processing Unit) 11 and a memory 12. CPU 11 executes a predetermined program. Memory 12 stores the program executed by CPU 11, data of the program being executed and data of the result of execution of the program.

Tuner 32 extracts, from broadcast signals received by antenna 31, a broadcast signal corresponding to a channel selected according to a command signal from control unit 10. Tuner 32 outputs the extracted broadest signal to demodulator 33.

Demodulator 33 receives the broadcast signal from tuner 32 to demodulate the broadcast signal into an MPEG-2TS (Moving Picture Experts Group phase 2 Transport Stream) signal that is digital-coded video and audio, and outputs the MPEG-2TS signal to signal processing unit 34.

Signal processing unit 34 decodes the MPEG-2TS signal received from demodulator 33 into a video signal and an audio signal. Signal processing unit 34 converts the video signal generated by the decoding into a panel signal for controlling to drive liquid crystal panel 51 so as to display video, and outputs the panel signal to liquid crystal panel 51. Further, signal processing unit 34 outputs the audio signal generated by the decoding to speaker 61.

Remote control reception unit 21 receives a command from a remote controller 22 to output a command signal indicating the received command to control unit 10. A user transmits the command by means of remote controller 22 so that a desired operation concerning reception of a television program is performed by liquid crystal television receiver 100.

Liquid crystal panel 51 allows light from backlight 52 to pass at a transmittance that is controlled by applying a voltage indicated by the panel signal to the liquid crystal individually for pixels colored with three primary colors of light, so as to display an image that is a collection of pixels. Backlight 52 is an illumination apparatus providing light from behind to liquid crystal panel 51.

While backlight 52 in the present embodiment is a light-emitting diode (hereinafter referred to as “LED”), the present invention is not limited to this. Alternatively, any of other illumination apparatuses such as an EL (Electro-Luminescence) apparatus may be used.

While the description of the present embodiment is applied to transmissive liquid crystal panel 51, it is not limited to this. Alternatively, a reflective liquid crystal panel with a front light may be used. In this case, light from the front light is reflected at a reflectance that is controlled individually for pixels so as to display an image.

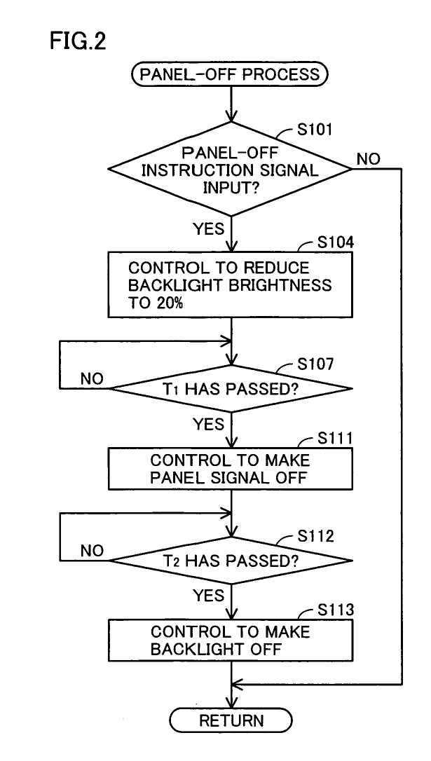

Referring to FIG. 2, a panel-off process is performed for example by being regularly called from a main process that is the caller of this panel-off process.

In step S101, control unit 10 of liquid crystal television receiver 100 determines whether or not a panel-off instruction signal is input.

The panel-off instruction signal may be an actual signal or what is regarded as output of a signal when predetermined data is written in a predetermined region of memory 12 of control unit 10, for example, flag.

The panel-off instruction signal is provided when, for example, the power of liquid crystal television receiver 100 is to be turned off. However, this is not a limitation and the panel-off instruction signal may be provided when audio-only contents without video are input to television receiver 100, for example, such an audio broadcast as FM (Frequency-Modulation) broadcast is received.

When it is determined that the panel-off instruction signal is not input (NO in step S101), control unit 10 ends the panel-off process to return the operation to be executed to the process of the caller of the panel-off process.

In contrast, when it is determined that the panel-off instruction signal is input (YES in step S101), control unit 10 controls in step S104 the brightness of backlight 52 so that the brightness is reduced to 20% of a maximum brightness.

This is not a limitation and the brightness may be controlled to have another brightness, on the condition that the brightness of backlight 52 is controlled to have the brightness of a level that is invisible to human eyes. For example, the brightness may be controlled to become any of other predetermined values in the range from a minimum brightness to approximately 30% of a maximum brightness of backlight 52, although it may depend on the performance of backlight 52. Alternatively, the brightness may be controlled to have any value according to the ambient illuminance of television receiver 100, presence of a person, a time of day for example.

Here, the brightness of a level invisible to human eyes varies individual to individual and also varies depending on the ambient illuminance. Therefore, it is preferable to collect statistics about the invisible brightness of various individuals and at various illuminances and control the brightness so that the brightness is lower than a lowest one of brightnesses statistically collected. In this way, as a value of the brightness of backlight 52 that is reduced under control, a statistical value is used to ensure that the brightness of backlight 52 as reduced under control is a brightness invisible to human eyes.

Then, in step S107, control unit 10 determines whether or not a time T₁ has passed since the time when the brightness of backlight 52 is reduced under control in step S104. The time is measured by means of a timer function of CPU 11 of control unit 10. Time T₁ is a time of the order of several hundreds milliseconds, for example, 300 milliseconds.

On the condition that time T₁ is equal to or longer than a time period from the time when step S104 is performed to start the control operation of CPU 11 to the time when the reduction control of the brightness of backlight 52 is actually completed, time T₁ may be any time of another order.

Further, in step S107, it may be determined whether or not time T₁ has passed since the time when the process proceeds to step S107.

When it is determined that time T₁ has not passed (NO in step S107), control unit 10 repeats the operation in step S107. In contrast, when it is determined that time T₁ has passed (YES in step S107), control unit 110 controls in step S111 the panel signal so that the panel signal changes from the ON state to the OFF state. Thus, liquid crystal panel 51 is in the state without control.

However, since backlight 52 is controlled in step S104 so that the brightness is invisible to human eyes, any disturbance in image displayed on liquid crystal panel 51 without control can be prevented from being visible to a user.

In step S112, control unit 10 determines whether or not a time T₂ has passed from the time when the panel signal is controlled in step S111 to become the OFF state. Time T₂ is a considerably short time period of several hundreds milliseconds or shorter, for example, zero millisecond.

Here, time T₂ may be any time in the range from zero millisecond to several hundreds milliseconds. Further, the panel-off process may not include the operation in step S112. Even in this case, the subsequent operation is performed after at least one clock of CPU 11 from the time when the operation in step S111 is performed.

Further, in step S112, it may be determined whether or not time T₂ has passed since the time when the process proceeds to the operation in step S112.

When it is determined that time T₂ has not passed (NO in step S112), control unit 10 repeats the operation in step S112. In contrast, when it is determined that time T₂ has passed (YES in step S112), control unit 10 controls in step S113 backlight 52 so that backlight 52 changes from the ON state to the OFF state. Thus, the brightness of backlight 52 becomes zero.

After step S113, control unit 10 ends the panel-off process and returns the operation to be performed to the process of the caller of the panel-off process.

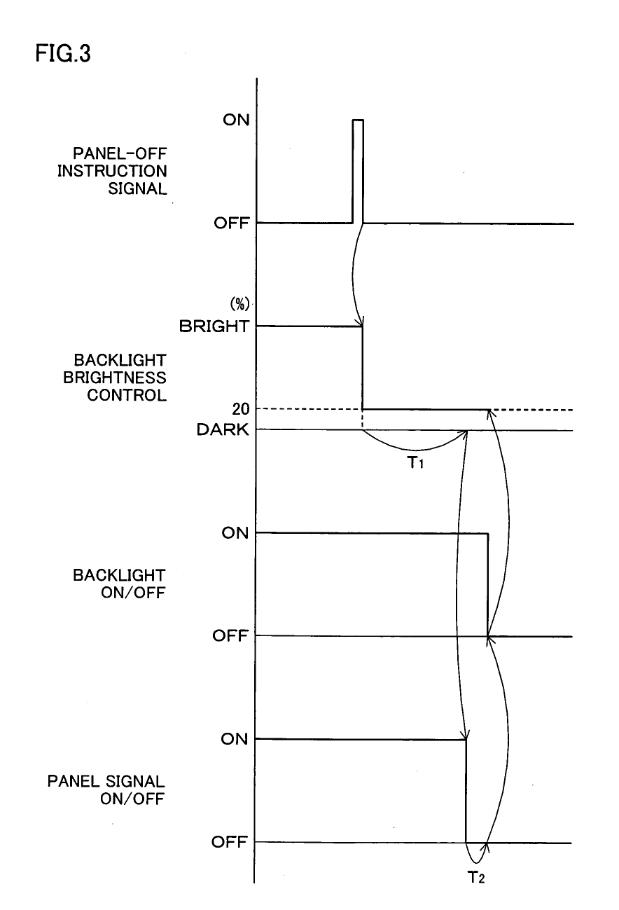

Referring to FIG. 3, the timing chart is the one when the panel-off process described in connection with FIG. 2 is carried out. First, the panel-off instruction signal is changed from the OFF state to the ON state. Accordingly, the brightness of the backlight is controlled to become 20% of a maximum brightness.

Then, after time T₁ has passed since the time when the brightness of the backlight is reduced under control, the panel signal is changed from the ON state to the OFF state. After time T₂ has passed since the time when the panel signal is controlled to become the OFF state, backlight 52 is controlled to change from the ON state to the OFF state. Accordingly, the brightness of backlight 52 becomes zero smaller than a minimum brightness.

As described above, liquid crystal television receiver 100 in the first embodiment reduces the brightness of backlight 52 to a brightness invisible to human eyes as described in connection with step S104 in FIG. 2. The backlight generates light to be passed through liquid crystal panel 51 so as to form an image.

As described in connection with step S111 in FIG. 2, the brightness is reduced and thereafter the panel signal to liquid crystal panel 51 is controlled so that the panel signal is changed from the ON state to the OFF state. As described in connection with step S113 in FIG. 2, the panel signal is controlled to become the OFF state and thereafter backlight 52 is controlled to change from the ON state to the OFF state.

Therefore, by controlling backlight 52 of liquid crystal panel 51, any disturbance in image, which could be generated when the panel signal to liquid crystal panel 51 is changed from the ON state to the OFF state, can be prevented from being seen by the user.

Further, as described in connection with step S101 and step S104 in FIG. 2, on the condition that the panel-off instruction signal for instructing to stop the function of liquid crystal panel 51 is input, the brightness of backlight 52 is reduced.

In addition, as described in connection with step S104 in FIG. 2, the brightness of backlight 52 is reduced to 20% of a maximum brightness of backlight 52 that is a predetermined brightness invisible to human eyes.

Therefore, it is unnecessary to calculate the brightness controlled to be reached when the brightness is to be reduced. Consequently, the brightness can more easily be reduced.

### Second Embodiment

In the first embodiment, the backlight brightness is controlled to be reduced at a time to a predetermined brightness which is invisible to human eyes, and thereafter the panel signal is controlled to change to the OFF state. In a second embodiment, the backlight brightness is gradually reduced in stepwise manner and thereafter the panel signal is controlled to change to the OFF state.

Here, the configuration of a liquid crystal television receiver 100A in the second embodiment is similar to that of liquid crystal television receiver 100 in the first embodiment as described in connection with FIG. 1, and thus the description thereof is not repeated.

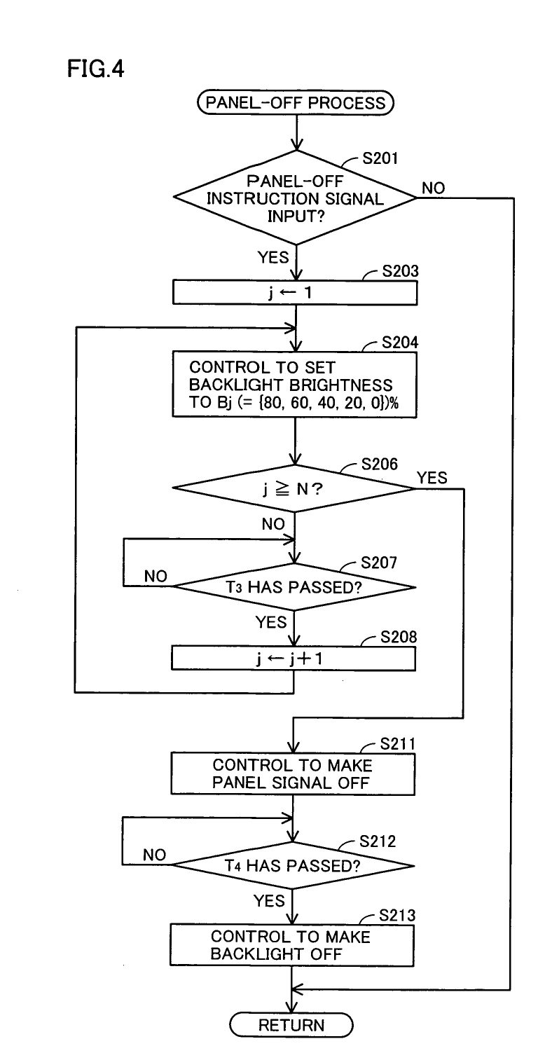

Referring to FIG. 4, a panel-off process is performed for example by being regularly called from a main process that is the caller of this panel-off process.

In step S201, control unit 10 of liquid crystal television receiver 100A determines whether or not the panel-off instruction signal is input.

When it is determined that the panel-off instruction signal is not input (NO in step S201), control unit 10 ends this panel-off process to return the operation to be executed to the process that is the caller of this panel-off process.

In contrast, when it is determined that the panel-off instruction signal is input (YES in step S201), control unit 10 substitutes 1 for a variable j in step S203.

Then, in step S204, control unit 10 controls the brightness of backlight 52 so that the brightness becomes Bⱼ% of a maximum brightness. Here, Bj={80, 60, 40, 20, 0}. When the operation in step S204 is performed for the first time, variable j is 1 (j=1) and thus the brightness of backlight 52 is controlled so that the brightness is B₁=80% of the maximum brightness. In the present embodiment, it is supposed that B₅=0% of the maximum brightness does not refer to the brightness of zero, but refers to a minimum brightness.

In step S206, control unit 10 determines whether or not the relation j≧N is satisfied. N is a constant and N is 5 (N=5) here. When it is determined that the relation j≧N is satisfied (YES in step S206), control unit 10 advances the operation to be executed to step S211.

In contrast, when it is determined that the relation j≧N is not satisfied (NO in step S206), control unit 10 determines in step S207 whether or not a time T₃ has passed since the time when the brightness of backlight 52 is controlled to become Bⱼ% of the maximum brightness. Time T₃ is a time of the order of several tens milliseconds, for example, 50 milliseconds.

On the condition that time T₃ is equal to or longer than a time period from the time when step S204 is performed to start the control operation of CPU 11 to the time when the reduction control of the brightness of backlight 52 is actually completed, time T₃ may be any time of another order.

Further, in step S207, it may be determined whether or not time T₃ has passed since the time when the process proceeds to step S207.

When it is determined that time T₃ has not passed (NO in step S207), control unit 10 repeats the operation in step S207. In contrast, when it is determined that time T₃ has passed (YES in step S207), control unit 10 adds 1 to the value of j in step S208. After step S208, control unit 10 returns the operation to be executed to the operation in step S204.

For example, in the case where j is 4 (j=4) before the operation in step S208 is performed, step S208 provides j=5 and step S204 controls the backlight brightness to so that the brightness becomes B₅=0% of the maximum brightness, namely controls the brightness so that the brightness becomes the minimum brightness as described above. In step S206 in which j=N=5 is provided, it is determined that the relation j≧N is satisfied. Then, the operation to be executed is advanced to the operation in step S211.

In step S211, control unit 10 controls the panel signal so that the panel signal changes from the ON state to the OFF state. Thus, liquid crystal panel 51 is in the state without control. However, as step S204 is executed multiple times, the brightness of backlight 52 gradually approaches in stepwise manner to the minimum brightness. Therefore, any disturbance in image displayed on liquid crystal panel 51 without controlled can be prevented from being visible to the user.

Then, in step S212, control unit 10 determines whether or not a time T₄ has passed since the time when the panel signal is controlled to change to the OFF state in step S211. Time T₄ is a considerably short time period equal to or shorter than several hundreds milliseconds, for example, zero millisecond.

Here, time T₄ may be any time from zero millisecond to several hundreds milliseconds. Further, the panel-off process may not include the operation in step S212. Even in this case, the subsequent operation is performed after at least one clock of CPU 11 from the time when the operation in step S211 is performed.

Further, in step S212, it may be determined whether or not time T₄ has passed since the time when the operation is advanced to step S212.

When it is determined that time T₄ has not passed (NO in step S212), control unit 10 repeats the operation in step S212. In contrast, when it is determined that time T₄ has passed (YES in step S212), control unit 10 controls in step S213 backlight 52 so that it changes from the ON state to the OFF state. Accordingly, the brightness of backlight 52 becomes zero.

After step S213, control unit 10 ends the panel-off process to return the operation to be performed to the process that is the caller of the panel-off process.

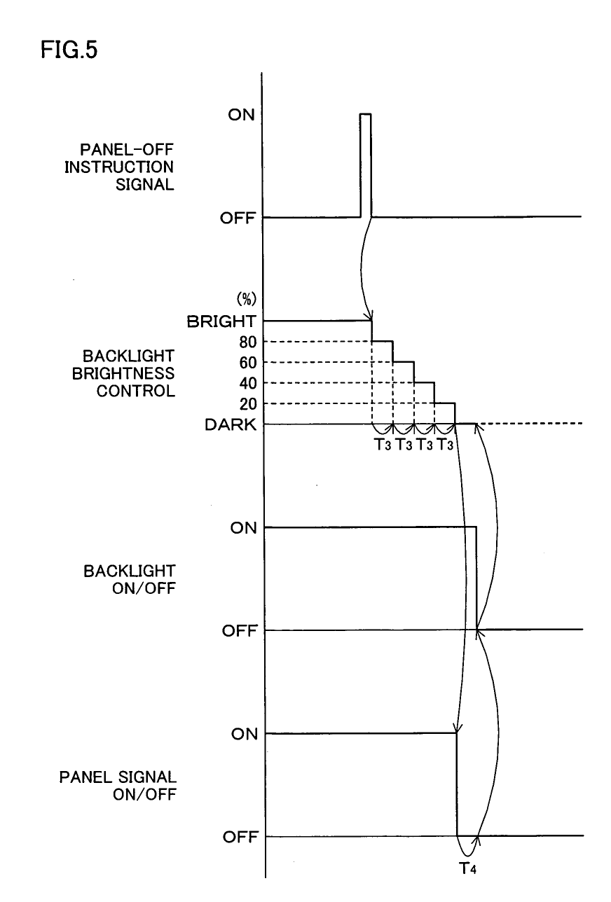

Referring to FIG. 5, the timing chart is the one when the panel-off process is performed as described in connection with FIG. 4. First, the panel-off instruction signal is changed from the OFF state to the ON state. Accordingly, the brightness of the backlight is controlled to become B₁=80% of the maximum brightness.

Then, each time the time T₃ passes, the brightness of the backlight is controlled to be reduced gradually in stepwise manner, namely by 20% of the maximum brightness per time T₃, in the manner of B₂=60%, B₃=40%, B₄=20%, B₅=0%. After the controlled reduction, the panel signal is controlled to change from the ON state to the OFF state.

After time T₄ has passed since the time when the panel signal is controlled to change to the OFF state, backlight 52 is controlled to change from the ON state to the OFF state. Thus, backlight 52 has its brightness of zero lower than the minimum brightness.

As described above, liquid crystal television receiver 100A in the second embodiment gradually reduces the brightness of backlight 52 as described in connection with steps S203 to S208 in FIG. 4. The backlight generates light to be passed through liquid crystal panel 51 so as to form an image.

As described in connection with step S211 in FIG. 4, the brightness is reduced and thereafter the panel signal to liquid crystal panel 51 is controlled to change from the ON state to the OFF state. As described in connection with step S213 in FIG. 4, the panel signal is controlled to become the OFF state and thereafter backlight 52 is controlled to change from the ON state to the OFF state.

Therefore, as compared with the case where the brightness is reduced at a time, the degree of brightness change per time is smaller and thus the degree of change in electric power supplied to backlight 52 can be reduced. As a result, the degree of change in load of electric power of liquid crystal television receiver 100A can be reduced. Further, the stability of the power supply voltage of liquid crystal television receiver 100A can be improved.

As described in connection with step S201 and step S204 in FIG. 4, on the condition that the panel-off signal for instructing to stop the function of liquid crystal panel 51 is input, the brightness of backlight 52 is reduced.

Further, as described in connection with steps S203 to S208, the brightness is successively changed to Bⱼ (={80, 60, 40, 20, 0}) % of the maximum brightness that are a plurality of predetermined brightnesses set respectively so that the brightness is reduced in stepwise manner.

Thus, it is unnecessary to calculate the brightness that is a reduced brightness under control. Consequently, the brightness can more easily be reduced.

Furthermore, as described in connection with step S204 and step S211 in FIG. 4, the brightness of backlight 52 is gradually reduced to a brightness invisible to human eyes, namely 20% and 0% of the maximum brightness. After the brightness is reduced, the panel signal to liquid crystal panel 51 is controlled to change from the ON state to the OFF state. Thus, backlight 52 of liquid crystal panel 51 is controlled to easily prevent disturbance in image, which occurs when the panel signal to liquid crystal panel 51 is changed from the ON state to the OFF state, from being seen by the user.

### Third Embodiment

In the second embodiment, the backlight brightness is gradually reduced in stepwise manner and thereafter the panel signal is controlled to change to the OFF state. In a third embodiment, the backlight brightness is gradually reduced in stepwise manner so that the brightness becomes lower than a predetermined brightness invisible to human eyes, and thereafter the panel signal is controlled to change to the OFF state.

Here, the configuration of a liquid crystal television receiver 100B in the third embodiment is similar to that of liquid crystal television receiver 100 in the first embodiment as described in connection with FIG. 1, and thus the description thereof is not repeated.

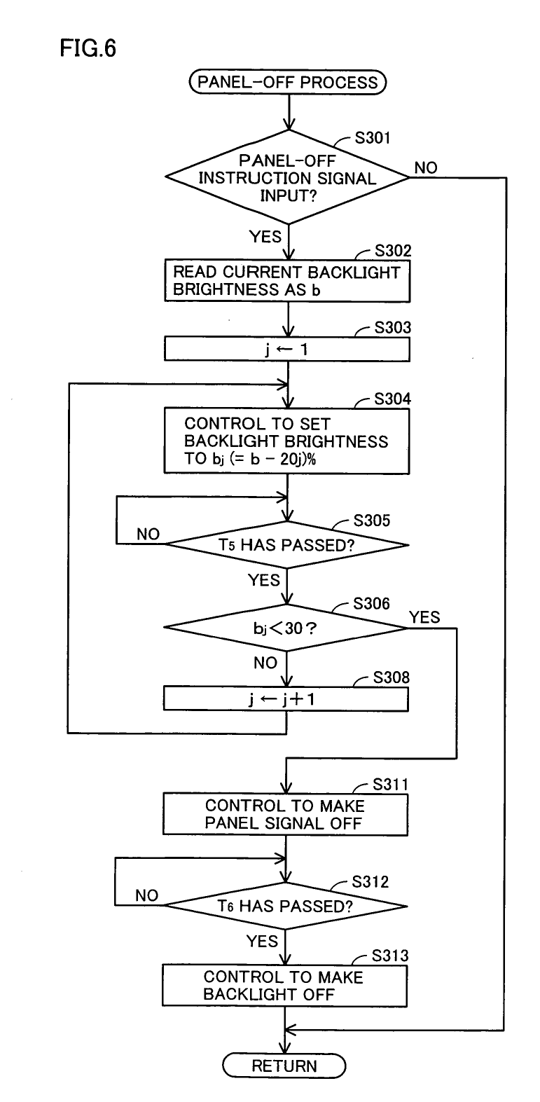

Referring to FIG. 6, a panel-off process is performed for example by being regularly called from a main process that is the caller of this panel-off process.

In step S301, control unit 10 of liquid crystal television receiver 100B determines whether or not the panel-off instruction signal is input.

When it is determined that the panel-off instruction signal is not input (NO in step S301), control unit 10 ends this panel-off process to return the operation to be executed to the process that is the caller of this panel-off process.

In contrast, when it is determined that the panel-off instruction signal is input (YES in step S301), control unit 10 reads the current brightness of backlight 52 and substitutes the value of this brightness for a variable b in step S302. The current brightness value of backlight 52 is stored in a predetermined storage region of memory 12 of control unit 10. Then, control unit 10 substitutes 1 for a variable j in step S303.

Then, in step S304, control unit 10 controls the brightness of backlight 52 so that the brightness becomes bⱼ% of a maximum brightness. Here, bⱼ=b−20j. When brightness b that is read in step S302 is 80 (b=80) and the operation in step S304 is performed for the first time, j is 1 (j=1). Therefore, the brightness of backlight 52 is controlled so that the brightness becomes b₁=80−20×1=60%.

In the subsequent step S305, control unit 10 determines whether or not a time T₅ has passed since the time when the brightness of the backlight is controlled in step S304. Time T₅ is a time of the order of several tens milliseconds, for example, 50 milliseconds.

On the condition that time T₅ is equal to or longer than a time period from the time when step S304 is performed to start the control operation of CPU 11 to the time when the control of the brightness of backlight 52 is actually completed, time T₅ may be any time of another order.

Further, in step S305, it may be determined whether or not time T₅ has passed since the time when the process proceeds to step S305.

When it is determined that time T₅ has not passed (NO in step S305), control unit 10 repeats the operation in step S305.

In contrast, when it is determined that time T₅ has passed (YES in step S305), control unit 10 determines in step S306 whether or not the relation bⱼ<30 is satisfied. Here, what is to be compared with bⱼ is not limited to 30% of the maximum brightness and another brightness may be compared with bⱼ on the condition that the brightness has a level invisible to human eyes.

For example, what is to be compared with bⱼ may be another predetermined value in the range from the minimum brightness to approximately 30% of the maximum brightness of backlight 52, although it depends on the performance of backlight 52. Alternatively, what is to be compared with bⱼ may be a value according to the ambient illuminance of television receiver 100B, presence of a person, a time of day for example.

When it is determined that the relation bⱼ<30 is satisfied (YES in step S306), control unit 10 advances the operation to be executed to the operation in step S311. In contrast, when it is determined that the relation bⱼ<30 is not satisfied (NO in step S306), control unit 10 adds 1 to the value of j in step S308. After step S308, control unit 10 returns the operation to be executed to the operation in step S304.

For example, in the case where j is 2 (j=2) and bⱼ is 40 (bⱼ=40) before the operation in step S306 is performed, it is determined in step S306 that the relation bⱼ<30 is not satisfied. Then, in step S308, 1 is added to j (j=3). Then, in step S304, the backlight brightness is set to bⱼ=80−20×3=20% of the maximum brightness. In step S306, it is determined that the relation bⱼ<30 is satisfied and the operation to be executed is advanced to the operation in step S311.

In step S311, control unit 10 controls the panel signal so that the panel signal changes from the ON state to the OFF state. Thus, liquid crystal panel 51 is in the state without control. However, in step S306, in the case where the brightness of backlight 52 is lower than a brightness invisible to human eyes, the panel signal is changed to the OFF state. Therefore, any disturbance in image displayed on liquid crystal panel 51 without controlled can be prevented from being seen by the user.

Then, in step S312, control unit 10 determines whether or not a time T₆ has passed since the time when the panel signal is controlled to change to the OFF state in step S311. Time T₆ is a considerably short time period equal to or shorter than several hundreds milliseconds, for example, zero millisecond.

Here, time T₆ may be any time from zero millisecond to several hundreds milliseconds. Further, the panel-off process may not include the operation in step S312. Even in this case, the subsequent operation is performed after at least one clock of CPU 11 from the time when the operation in step S311 is performed.

Further, in step S312, it may be determined whether or not time T₆ has passed since the time when the operation is advanced to step S312.

When it is determined that time T₆ has not passed (NO in step S312), control unit 10 repeats the operation in step S312. In contrast, when it is determined that time T₆ has passed (YES in step S312), control unit 10 controls in step S313 backlight 52 so that it changes from the ON state to the OFF state. Accordingly, the brightness of backlight 52 becomes zero.

After step S313, control unit 10 ends the panel-off process to return the operation to be performed to the process that is the caller of the panel-off process.

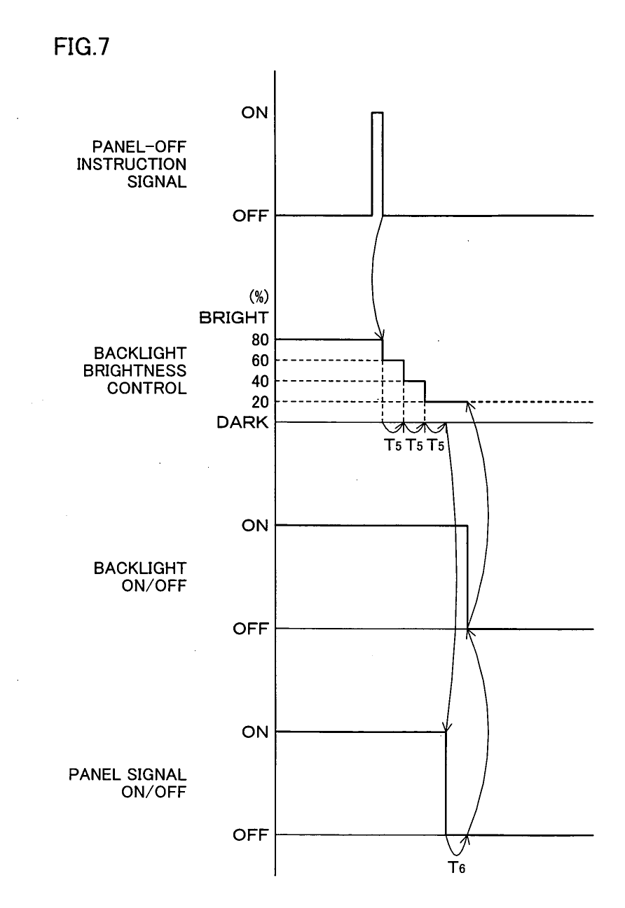

Referring to FIG. 7, the timing chart is the one when the panel-off process is performed as described in connection with FIG. 6. First, the panel-off instruction signal is changed from the OFF state to the ON state. Here, the backlight brightness is 80% of the maximum brightness. Accordingly, the backlight brightness is controlled to become b₁=80−20×1=60% of the maximum brightness.

Then, each time the time T₅ passes, the brightness of the backlight is controlled to be reduced gradually in stepwise manner like b₂=80−20×2=40%, b₃=80−20×3=20% of the maximum brightness, until the relation bⱼ<30 is satisfied. After time T₅ has passed since the time when the relation bⱼ<30 is satisfied, the panel signal is controlled to change from the ON state to the OFF state.

After a time T₆ has passed since the time when the panel signal is controlled to change to the OFF state, backlight 52 is controlled to change to the OFF state. Accordingly, the brightness of backlight 52 becomes zero lower than the minimum brightness.

As described above, liquid crystal television receiver 100B in the third embodiment gradually reduces the brightness of backlight 52 by 20% of the maximum brightness per time T₅ until the brightness becomes lower than the brightness which is 30% of the maximum brightness, namely the brightness which is invisible to human eyes. The backlight generates light to be passed through the liquid crystal panel so as to form an image.

As described in connection with step S311 in FIG. 6, the brightness is reduced and thereafter the panel signal to liquid crystal panel 51 is controlled to change from the ON state to the OFF state. As described in connection with step S313 in FIG. 6, the panel signal is controlled to become the OFF state and thereafter backlight 52 is controlled to change from the ON state to the OFF state.

Thus, backlight 52 of liquid crystal panel 51 is controlled to easily prevent disturbance in image, which occurs when the panel signal to liquid crystal panel 51 is changed from the ON state to the OFF state, from being seen by the user.

Further, since the degree of brightness change per time is smaller and thus the degree of change in electric power supplied to backlight 52 can be reduced. As a result, the degree of change in load of electric power of liquid crystal television receiver 100B can be reduced. Further, the stability of the power supply voltage of liquid crystal television receiver 100B can be improved.

As described in connection with step S301 and step S304 in FIG. 6, on the condition that the panel-off signal for instructing to stop the function of liquid crystal panel 51 is input, the brightness of backlight 52 is reduced.

### Fourth Embodiment

In the first embodiment, the backlight brightness is controlled to be reduced to a predetermined brightness that is invisible to human eyes, and thereafter the panel signal is controlled to change to the OFF state. In a fourth embodiment, the backlight brightness is controlled to be reduced to a brightness invisible to human eyes according to the ambient luminance, and thereafter the panel signal is controlled to change to the OFF state.

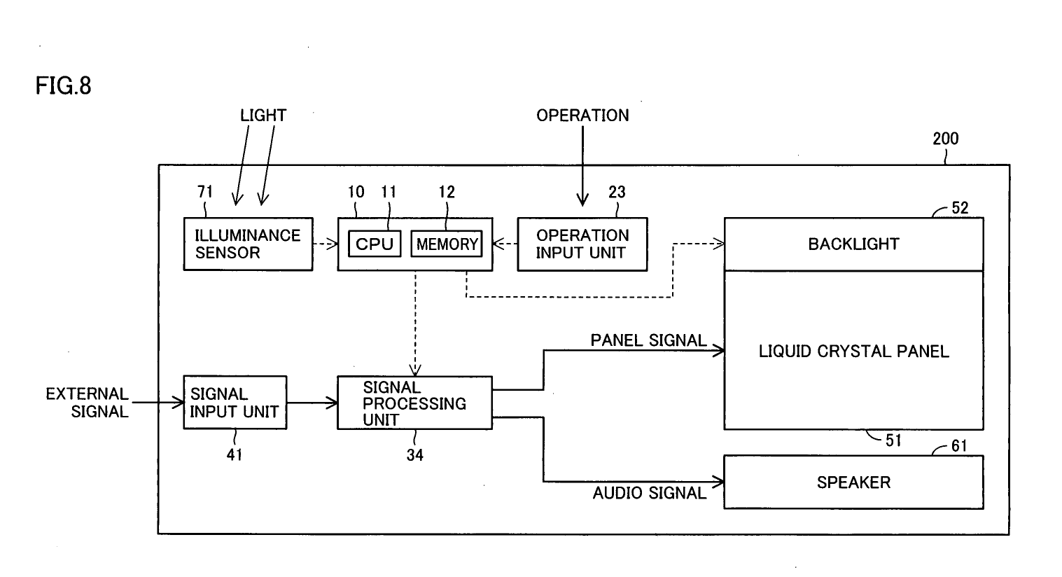

Referring to FIG. 8, a liquid crystal monitor 200 includes a control unit 10, an operation input unit 23, a signal processing unit 34, a signal input unit 41, a liquid crystal panel 51, a backlight 52, a speaker 61, and an illuminance sensor 71.

Control unit 10, liquid crystal panel 51, backlight 52, and speaker 61 are similar to those described in connection with FIG. 1 in the first embodiment, and thus the description thereof is not repeated.

Operation input unit 23 accepts operation of a user to output, to control unit 10, an operation signal indicating the accepted operation. The user performs a predetermined operation with operation input unit 23 in order to allow liquid crystal monitor 200 to perform a desired operation concerning reproduction of an external signal.

Signal input unit 41 accepts input of an external signal from an external device for reproducing video, audio or the like, and outputs the accepted external signal to signal processing unit 34.

The external device refers to, for example, such a recording medium reproduction apparatus as DVD (Digital Versatile Disk) player, videocassette recorder and CD (Compact Disc) player, a receiver receiving a television broadcast and a radio broadcast, a set-top box for the cable television system or wired broadcasting, and such an information communication device as PC (Personal Computer), gateway, router, and base station of a wireless LAN (Local Area Network).

The external signal refers to a video signal or an audio signal communicated by means of any of composite terminal, S-terminal, D-terminal, component terminal HDMI (High-Definition Multimedia Interface ) (registered), D-Sub (D-Subminiature) terminal, DVI (Digital Visual Interface) terminal, DV (Digital Video) terminal, IEEE (Institute of Electrical and Electronic Engineers) 1394 terminal, and USB (Universal Serial Bus) terminal.

Signal processing unit 34 separates the external signal received from signal input unit 41 into a video signal and an audio signal to output the audio signal to speaker 61. Further, signal processing unit 34 converts the separated video signal into a panel signal for driving and controlling liquid crystal panel 51 to display video, and outputs the panel signal to liquid crystal panel 51.

Illuminance sensor 71 is a sensor measuring the illuminance around liquid crystal monitor 200 and formed for example of a photodiode. Illuminance sensor 71 transmits to control unit 10 a signal according to the illuminance.

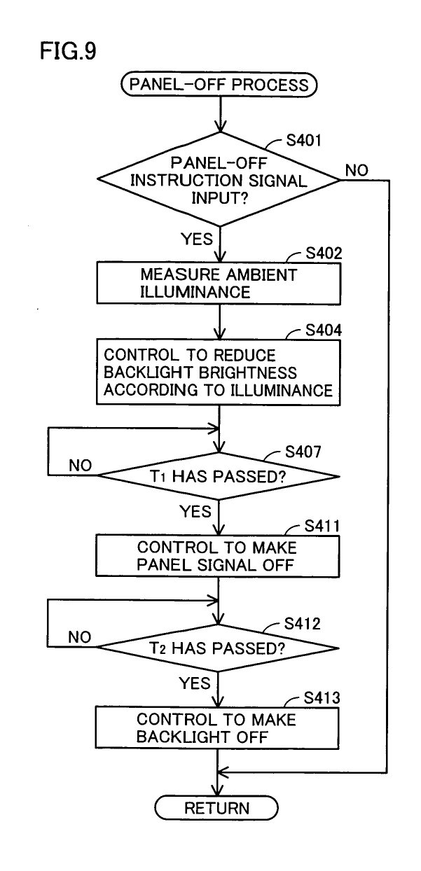

Referring to FIG. 9, a panel-off process is performed for example by being regularly called from a main process that is the caller of this panel-off process.

In step S401, control unit 10 of liquid crystal monitor 200 determines whether or not the panel-off instruction signal is input.

The panel-off signal is given when, for example, the power of liquid crystal monitor 200 is to be turned off. However, this is not a limitation and the panel-off signal may be given when, for example, audio-only contents without video are input to liquid crystal monitor 200, or a signal from a CD player is input to liquid crystal monitor 200. If liquid crystal monitor 200 is to be used for the PC, the panel-off signal may be given when a predetermined time passes and the resuming capability functions.

When it is determined that the panel-off instruction signal is not input (NO in step S401), control unit 10 ends the panel-off process to return the operation to be executed to the process of the caller of the panel-off process.

In contrast, when it is determined that the panel-off instruction signal is input (YES in step S401), control unit 10 measures in step S402 the illuminance of the ambient of liquid crystal monitor 200 based on a signal from illuminance sensor 71.

Then, in step S404, control unit 10 controls, according to the measured illuminance, the brightness of backlight 52 so that the brightness is reduced. Here, in the case where the measured illuminance is equal to or higher than a predetermined value, the brightness of backlight 52 is controlled to be reduced to 20% of a maximum brightness. In the case where the measured illuminance is less than the predetermined value, the brightness of backlight 52 is controlled to be reduced to 10% of the maximum brightness. Here, the reduced brightness is a brightness invisible to human eyes at the illuminance at that time.

The method of controlling to reduce the brightness of backlight 52 is not limited to the above-described one. The brightness may be controlled in multi-step manner having more than two steps, or the brightness may be controlled so that the brightness is proportional to the illuminance, or the brightness may be controlled to have a value calculated from the illuminance by means of a predetermined relational expression.

The operations in subsequent steps S407 to S413 are similar to those of steps S107 to S113 described in connection with FIG. 1, and thus the description thereof is not repeated.

As described above, liquid crystal monitor 200 in the fourth embodiment measures the illuminance of the ambient of liquid crystal monitor 200 by means of illuminance sensor 71 as described in connection with FIG. 8. As described in connection with step S404 in FIG. 9, the brightness of backlight 52 is reduced to a brightness invisible to human eyes according to the measured illuminance.

Therefore, the brightness of backlight 52 can be controlled according to ambient conditions of liquid crystal monitor 200.

In the fourth embodiment, according to the ambient illuminance, the brightness of backlight 52 is controlled to be reduced to a brightness invisible to human eyes as done in the first embodiment. However, the brightness of backlight 52 may be controlled to be gradually reduced as done in the second embodiment, according to the ambient illuminance.

For example, if the measured illuminance is equal to or higher than a predetermined value, the brightness of backlight 52 is controlled so that the brightness gradually decreases in stepwise manner to 80%, 60%, 40%, 20% of the maximum brightness. If the measured illuminance is lower than the predetermined value, the brightness of backlight 52 may be controlled so that the brightness gradually decreases in stepwise manner to 80%, 60%, 35%, 10% of the maximum brightness.

Modification

In the embodiments discussed above, the present invention is described as applied to liquid crystal television receivers 100, 100A, 100B and liquid crystal monitor 200 having liquid crystal panel 51 and backlight 52. However, the present invention is not limited to this. The present invention may be applied to other devices, for example, a combination system, or a transmissive or reflective liquid crystal projector, on the condition that the device is an electric device including a liquid crystal panel and an illumination apparatus.

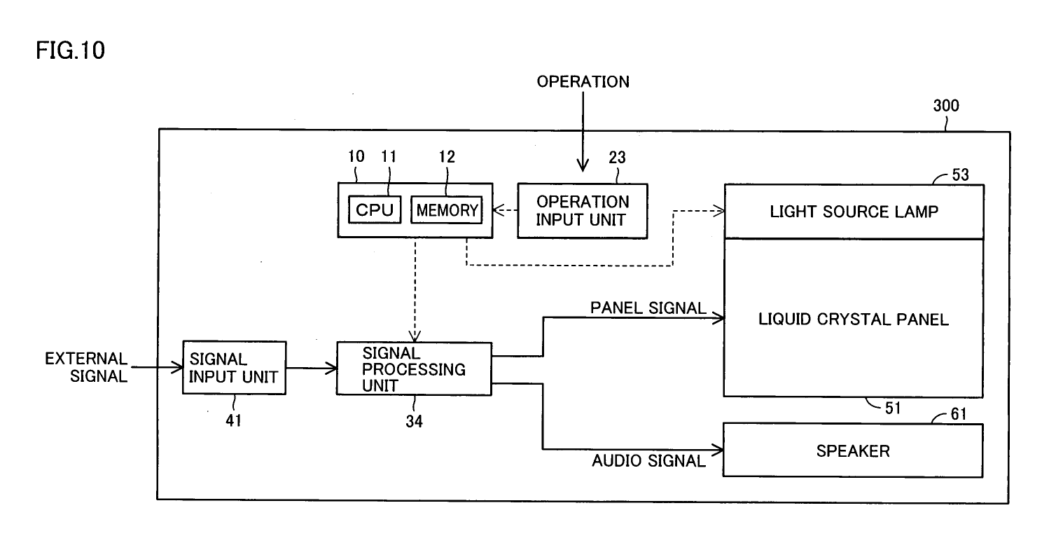

The combination system includes an apparatus combining a television and a videocassette recorder, an apparatus combining a television and a DVD recording and reproducing apparatus, and an apparatus combining a television and a hard disk recording and reproducing apparatus. As shown in FIG. 10, in the case where liquid crystal projector 300 is used, the illumination apparatus of liquid crystal panel 51 is a light source lamp 53 such as ultra-high-voltage mercury lamp.

In the embodiments discussed above, the present invention is described as an apparatus of liquid crystal television receivers 100, 100A, 100B and liquid crystal monitor 200. However, the present invention is not limited to this. The present invention may be applied to a liquid crystal display control method executing the processes described in connection with FIGS. 2, 4, 6 and 9 by liquid crystal television receivers 100, 100A, 100B and liquid crystal monitor 200 respectively.

Moreover, the present invention may be applied to a liquid crystal display control program executed by liquid crystal television receivers 100, 100A, 100B and liquid crystal monitor 200 as described in connection with FIGS. 2, 4, 6 and 9 respectively.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A liquid crystal television receiver comprising:
brightness reduction control means for reducing a brightness of backlight generating light to be passed through a liquid crystal panel and thereby forming an image, to a predetermined brightness invisible to human eyes, on condition that an instruction signal for instructing to stop function of said liquid crystal panel is input;
panel-off control means for controlling a video signal to said liquid crystal panel to be changed from an ON state to an OFF state, after the brightness is reduced by said brightness reduction control means; and
illumination-off control means for controlling said backlight to be changed from the ON state to the OFF state, after said video signal is controlled to be changed to the OFF state by said panel-off control means.

2. A liquid crystal display apparatus comprising:
brightness reduction control means for reducing a brightness of an illumination apparatus generating light to be passed through a liquid crystal panel or reflected from said liquid crystal panel and thereby forming an image, to a brightness invisible to human eyes;
panel-off control means for controlling a video signal to said liquid crystal panel to be changed from an ON state to an OFF state, after the brightness is reduced by said brightness reduction control means; and
illumination-off control means for controlling said illumination apparatus to be changed from the ON state to the OFF state, after said video signal is controlled to be changed to the OFF state by said panel-off control means.

3. The liquid crystal display apparatus according to claim 2, wherein
said brightness reduction control means reduces the brightness on condition that an instruction signal for instructing to stop function of the liquid crystal panel is input.

4. The liquid crystal display apparatus according to claim 2, wherein
said brightness reduction control means reduces the brightness to a predetermined brightness invisible to human eyes.

5. The liquid crystal display apparatus according to claim 4, wherein
said predetermined brightness is a minimum brightness of said illumination apparatus.

6. The liquid crystal display apparatus according to claim 2, further comprising illuminance measurement means for measuring an ambient illuminance of said liquid crystal display apparatus, wherein
said brightness reduction control means reduces the brightness to a brightness according to the illuminance measured by said illuminance measurement means.

7. The liquid crystal display apparatus according to claim 2, wherein
said brightness reduction control means gradually reduces the brightness.

8. The liquid crystal display apparatus according to claim 2, wherein
said illumination apparatus is a backlight.

9. A liquid crystal display control method for controlling a liquid crystal display apparatus, comprising the steps of:
reducing a brightness of an illumination apparatus generating light to be passed through a liquid crystal panel or reflected from said liquid crystal panel and thereby forming an image, to a brightness invisible to human eyes;
controlling a video signal to said liquid crystal panel to be changed from an ON state to an OFF state, after the brightness is reduced; and
controlling said illumination apparatus to be changed from the ON state to the OFF state after said video signal is controlled to be changed to the OFF state.
